(19) United States
(12) Patent Application Publication
(10) Pub. No.: US 2016/0091807 A1
(43) Pub. Date: Mar. 31, 2016

(54) ELECTROPHOTOGRAPHIC PHOTOSENSITIVE MEMBER, PROCESS CARTRIDGE, ELECTROPHOTOGRAPHIC APPARATUS AND PHTHALOCYANINE CRYSTAL

(71) Applicant: CANON KABUSHIKI KAISHA, Tokyo (JP)

(72) Inventors: Masato Tanaka, Tagata-gun (JP); Tsutomu Nishida, Mishima-shi (JP); Masataka Kawahara, Mishima-shi (JP)

(73) Assignee: CANNON KABUSHIKI KAISHA, Tokyo (JP)

(21) Appl. No.: 14/888,646

(22) PCT Filed: May 22, 2014
(86) PCT No.: PCT/JP2014/064202

§ 371 Date: Nov. 2, 2015

(30) Foreign Application Priority Data
May 28, 2013 (JP) 2013-111651

(51) Int. Cl. G03G 15/00

(52) U.S. Cl. CPC G03G 5/0696

(57) ABSTRACT

The present invention provides an electrophotographic photosensitive member comprising a support, and a photosensitive layer formed on the support, wherein the photosensitive layer contains a phthalocyanine crystal in which a 4-piperidone compound represented by the following formula (1) is contained.

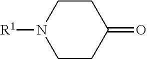

### TECHNICAL FIELD

The present invention relates to an electrophotographic photosensitive member, a process cartridge and an electrophotographic apparatus each having an electrophotographic photosensitive member, and a phthalocyanine crystal.

### BACKGROUND ART

Since the oscillation wavelength of a semiconductor laser commonly used as an image exposing device in the field of electrophotography is in the long wavelength range of 650 to 820 nm, electrophotographic photosensitive members having high sensitivity to the light in the long wavelength range are currently under development.

Phthalocyanine pigments are effective as charge generating substances having high sensitivity to the light ranging to such a long wavelength region. Oxytitanium phthalocyanine and gallium phthalocyanine in particular have excellent sensitivity properties, and various crystal forms have been reported until now.

Although an electrophotographic photosensitive member using a phthalocyanine pigment has excellent sensitivity properties, a problem is that the generated photo carriers tend to remain in a photosensitive layer so as to act as a memory, easily causing potential variation such as ghosting.

PTL 1 discloses that the addition of a specific organic electron acceptor to a phthalocyanine pigment during acid pasting has a sensitizing effect. This method has, however, problems that an additive (organic electron acceptor) may be subject to a chemical change and that the conversion to a desired crystalline form may be difficult in some cases.

PTL 2 discloses that wet crushing treatment of a pigment and a specific organic electron acceptor allows for simultaneous crystal transformation and incorporation of the organic electron acceptor in the surface of the crystal, resulting in improved electrophotographic properties.

PTL 3 discloses a hydroxygallium phthalocyanine crystal which contains a polar organic solvent. With use of a transformation solvent such as N,N-dimethylformamide, a polar organic solvent is incorporated in the crystal, so that a crystal having excellent sensitivity properties is produced.

### CITATION LIST

### Patent Literature

PTL 1: Japanese Patent Application Laid-Open No. 2001-40237

PTL 2: Japanese Patent Application Laid-Open No. 2006-72304

PTL 3: Japanese Patent Application Laid-Open No. H7-331107

### SUMMARY OF INVENTION

### Technical Problem

Various attempts have been made to improve electrophotographic photosensitive members as described above.

For further improvement in high-quality picture in recent years, it is desired to prevent image degradation due to ghosting in various environments. In the method according to PTL 2, the organic electron acceptors are not sufficiently contained in the produced phthalocyanine crystal, being in a simple mixture state or attached to the surface. Thus, there is a need for improvement. It was found that in the method described in PTL 3, the generated photo carriers are liable to remain in a photo sensitive layer so as to act as a memory, easily causing potential variation such as ghosting in some cases.

The present invention is directed to providing an electrophotographic photosensitive member which reduces image defects due to ghosting not only under a normal temperature and normal humidity environment but also even under a low temperature and low humidity environment, especially severe conditions. Further, the present invention is directed to providing a process cartridge and an electrophotographic apparatus each having the electrophotographic photosensitive member.

Furthermore, the present invention is directed to providing a phthalocyanine crystal which contains a specific 4-piperidone compound in the crystal.

### Solution to Problem

According to one aspect of the present invention, there is provided an electrophotographic photosensitive member comprising: a support; and a photosensitive layer formed on the support; wherein the photosensitive layer includes a phthalocyanine crystal in which a compound represented by the following formula (1) is contained:

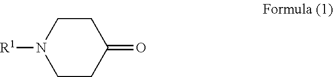

wherein R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted hetero ring group, with the proviso that, as a substituent of the substituted aryl group, an acetyl group and a benzoyl group are excluded.

According to another aspect of the present invention, there is provided a process cartridge which integrally supports the electrophotographic photosensitive member and at least one device selected from the group consisting of a charging device, a developing device, a transfer device and a cleaning device, the cartridge being detachably mountable to a main body of an electrophotographic apparatus.

According to further aspect of the present invention, there is provided an electrophotographic apparatus having the electrophotographic photosensitive member, with a charging device, an exposing device, a developing device and a transfer device.

According to further aspect of the present invention, there is provided a phthalocyanine crystal which contains a compound represented by the following formula (1) in the crystal.

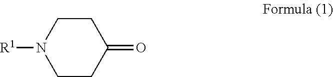

wherein R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted hetero ring group, with the proviso that, as a substituent of the substituted aryl group, an acetyl group and a benzoyl group are excluded.

### Advantageous Effects of Invention

The present invention can provide an electrophotographic photosensitive member which can output images with reduced image defects due to ghosting not only under a normal temperature and normal humidity environment but also even under a low temperature and low humidity environment, especially severe conditions. The present invention can also provide a process cartridge and an electrophotographic apparatus each having the electrophotographic photosensitive member.

The present invention can also provide a phthalocyanine crystal having excellent properties as a charge generating substance.

Further features of the present invention will become apparent from the following description of exemplary embodiments with reference to the attached drawings.

### BRIEF DESCRIPTION OF DRAWINGS

FIG. 1 is a schematic view of an electrophotographic apparatus provided with a process cartridge having an electrophotographic photosensitive member of the present invention.

FIG. 2 is a powder X-ray diffraction chart of a hydroxygallium phthalocyanine crystal obtained in Example 1-1.

FIG. 3 is a powder X-ray diffraction chart of a hydroxygallium phthalocyanine crystal obtained in Example 1-2.

FIG. 4 is a powder X-ray diffraction chart of a hydroxygallium phthalocyanine crystal obtained in Example 1-4.

FIG. 5 is a powder X-ray diffraction chart of a hydroxygallium phthalocyanine crystal obtained in Example 1-5.

### DESCRIPTION OF EMBODIMENTS

Preferred embodiments of the present invention will now be described in detail in accordance with the accompanying drawings.

As described above, an electrophotographic photosensitive member includes a support and a photosensitive layer formed on the support. According to the present invention, the photosensitive layer of the electrophotographic photosensitive member includes a phthalocyanine crystal in which a 4-piperidone compound represented by the following formula (1) is contained:

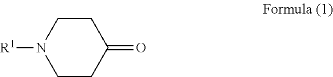

In the formula (1), R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted hetero ring group, with the proviso that, as a substituent of the substituted aryl group, an acetyl group and a benzoyl group are excluded.

The R¹ in the formula (1) can be a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted heterocyclic group. Examples of the substituent of the substituted alkyl group include an alkoxy group, a morpholinoalkoxy group, a dialkylamino group, an alkoxycarbonyl group, an aryl group, an aryloxy group, a halogen atom, a cyano group and a morpholino group. Examples of the substituent of the substituted aryl group include an alkyl group, an alkoxy group, a dialkylamino group, an alkoxycarbonyl group, a halogen atom, a nitro group, a cyano group, a formyl group and a morpholino group. Examples of the substituent of the substituted heterocyclic group include an alkyl group, an alkoxy group, a dialkylamino group, an alkoxycarbonyl group, a halogen atom, a nitro group, a cyano group, a formyl group and a morpholino group.

It is more preferred that the R¹ in the formula (1) be the substituted or unsubstituted alkyl group, and among them, a methyl group, an ethyl group, or a benzyl group is particularly preferred.

In the formula (1), R¹ more preferably represents the substituted or unsubstituted phenyl group, and particularly preferably represents the unsubstituted phenyl group. Examples of the substituent for the substituted phenyl group include an alkyl group, an alkoxy group, a halogen atom, a formyl group, a cyano group, and a nitro group.

Examples of the alkenyl group in the formula (1) include a 2-propenyl group, a 1-cyclohexenyl group and a 1-cyclopentenyl group.

Examples of the aryl group in the formula (1) include a phenyl group, a naphthyl group and a biphenyl group.

Examples of the heterocyclic group in the formula (1) include a pyridyl group, a pyrimidinyl group, an imidazolyl group, a thienyl group and a furyl group.

Examples of the substituent of the substituted or unsubstituted alkyl group in the formula (1) include an alkoxy group such as a methoxy group, an ethoxy group and a 2-(morpholino)-ethoxy group; a dialkylamino group such as a dimethylamino group and a diethylamino group; an alkokycarbonyl group such as a methoxycarbonyl group and an ethoxycarbonyl group; an aryl group such as a phenyl group, a naphthyl group, a biphenylyl group, a nitrophenyl group, a tolyl group, which may have a substituent; a heterocyclic group such as a pyridyl group, a pyrazinyl group, a pyrimidinyl group, a triazinyl group, an imidazolyl group, a thienyl group, a furyl group; a halogen atom such as a fluorine atom, a chlorine atom and a bromine atom; a nitro group; a cyano group; and a morpholino group.

Examples of the substituent of the substituted or unsubstituted aryl group in the formula (1) include an alkyl group such as a methyl group, an ethyl group and a propyl group; an alkoxy group such as a methoxy group and an ethoxy group; a dialkylamino group such as a dimethylamino group and a diethylamino group; an alkoxycarbonyl group such as a methoxycarbonyl group and an ethoxycarbonyl group; a halogen atom such as a fluorine atom, a chlorine atom and a bromine atom; a nitro group; a cyano group; and a formyl group.

Examples of the substituent of the substituted or unsubstituted heterocyclic group in the formula (1) include an alkyl group such as a methyl group and an ethyl group; an alkoxy group such as a methoxy group and an ethoxy group; a dialkylamino group such as a dimethylamino group and a diethylamino group; a halogen atom such as a fluorine atom, a chlorine atom and a bromine atom; a nitro group; a cyano group; a phenyl group; and a formyl group.

Although preferred specific examples (exemplary compounds) of the 4-piperidone compound contained in the phthalocyanine crystal are described in the following, the present invention is not limited thereto.

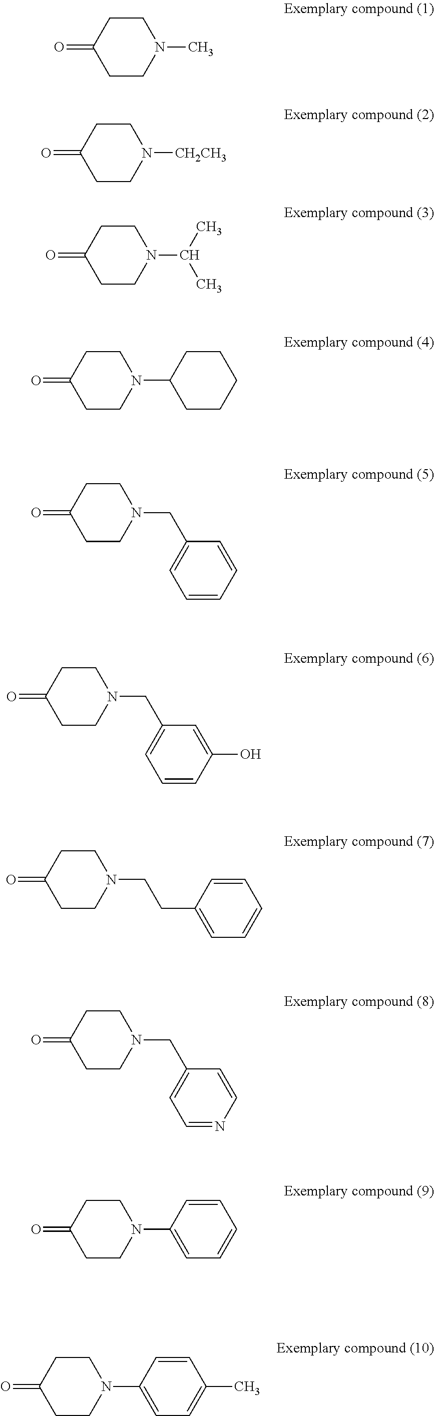

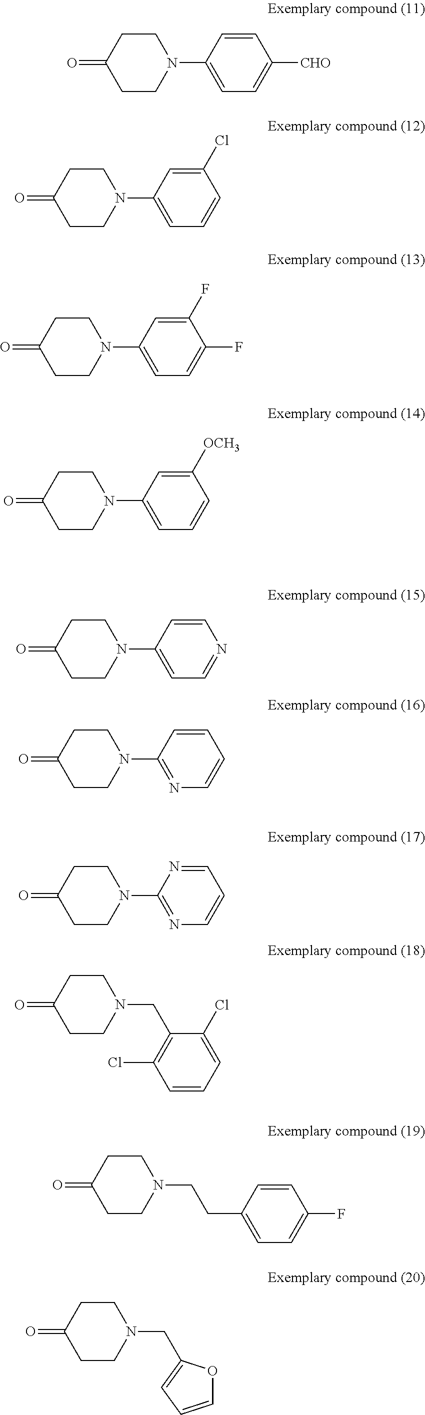

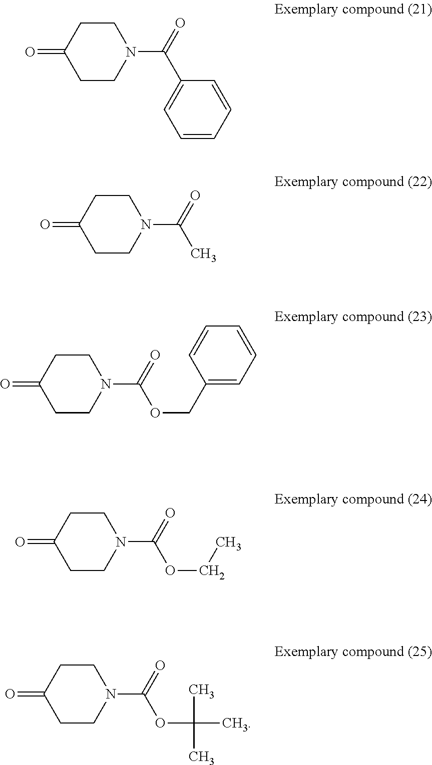

As described below, examples of the phthalocyanine which constitutes the phthalocyanine crystal which contains a compound represented by the formula (1) of the present invention in the crystal include a metal-free phthalocyanine and a metal phthalocyanine which may have an axial ligand, and the phthalocyanine may have a substituent. An oxytitanium phthalocyanine crystal and a gallium phthalocyanine crystal are preferred in particular, with excellent sensitivity, while easily causing ghosting.

As described below, examples of the gallium phthalocyanine to constitute the gallium phthalocyanine crystal which contains a compound represented by the formula (1) of the present invention in the crystal include a gallium phthalocyanine molecule of which gallium atom has an axial ligand of a halogen atom, a hydroxy group or an alkoxy group. The phthalocyanine ring may include a substituent such as a halogen atom.

A gallium phthalocyanine crystal further containing N,N-dimethylformamide in the crystal is preferred.

Among gallium phthalocyanine crystals, a hydroxygallium phthalocyanine crystal, a bromo-gallium phthalocyanine crystal and an iodo-gallium phthalocyanine crystal, having excellent sensitivity, are preferred, having sufficient effect of the present invention. A hydroxygallium phthalocyanine crystal is preferred in particular. The hydroxygallium phthalocyanine crystal includes a gallium atom having an axial ligand of hydroxy group. The bromo-gallium phthalocyanine crystal includes a gallium atom having an axial ligand of bromine atom. The iodo-gallium phthalocyanine crystal includes a gallium atom having an axial ligand of iodine atom.

A hydroxygallium phthalocyanine crystal having peaks at Bragg angles 2θ of 7.4°±0.3° and 28.3°±0.3° in X-ray diffraction with CuKα radiation in particular is more preferred, having effect of reducing image defects due to ghosting.

The content of a 4-piperidone compound represented by the formula (1) contained in the phthalocyanine crystal can be 0.01% by mass or more and 3% by mass or less.

In the phthalocyanine crystal which contains a compound represented by the formula (1) in the crystal, the compound represented by the formula (1) is incorporated into the crystal.

A manufacturing method of a phthalocyanine crystal which contains a 4-piperidone compound represented by the formula (1) in the crystal is described below.

The phthalocyanine crystal which contains a compound represented by the formula (1) in the crystal can be obtained by mixing phthalocyanine produced by acid pasting and a compound represented by the formula (1) with a solvent and by wet milling treatment for conversion into crystals.

The milling treatment is a treatment in a milling device such as a sand mill and a ball mill, using dispersion material such as glass beads, steel beads and alumina balls. The milling time can be about 1 to 100 hours. In a particularly preferred method, sampling is performed with an interval of 5 to 10 hours for examining the Bragg angle of the crystal. The amount of dispersion material in milling treatment can be 10 to 50 times the amount of gallium phthalocyanine by mass. Examples of the solvent for use include an amide solvent such as N,N-dimethylformamide, N,N-dimethylacetoamide, N-methylformamide, N-methylacetoamide, N-methylpropionamide and N-methyl-2-pyrrolidone, a halogen solvent such as chloroform, an ether solvent such as tetrahydrofuran, a sulfoxide solvent such as dimethyl sulfoxide. The amount of solvent used can be 5 to 30 times the amount of phthalocyanine by mass. The amount of a compound represented by the formula (1) used can be 0.1 to 30 times the amount of phthalocyanine by mass.

In the present invention, the measurement data of the obtained phthalocyanine crystal by NMR measurement and thermogravimetric (TG) measurement are analyzed to determine whether the phthalocyanine crystal of the present invention contained a 4-piperidone compound represented by the formula (1) in the crystal.

For example, when a milling treatment was performed with a solvent for dissolving a compound represented by the formula (1) or when a cleaning was performed after the milling treatment, NMR measurement of the obtained phthalocyanine crystal was performed. When a compound represented by the formula (1) is detected, it can be determined that a compound represented by the formula (1) was contained in the crystal.

On the other hand, when a compound represented by the formula (1) was insoluble in the solvent for use in the milling treatment and insoluble in the cleaning solvent after the milling treatment, NMR measurement of the obtained phthalocyanine crystal was performed. When a compound represented by the formula (1) was detected, determination was performed by the following method.

The TG measurement of each of the phthalocyanine crystal obtained by adding a compound represented by the formula (1), a phthalocyanine crystal prepared in the same way except that no compound represented by the formula (1) was added, and a compound represented by the formula (1) alone was individually performed. When the TG measurement results of the phthalocyanine crystal obtained by adding a compound represented by the formula (1) were interpreted from a mixture of the individual measurement results of the phthalocyanine crystal prepared without addition of a compound represented by the formula (1) and a compound represented by the formula (1) in a predetermined ratio, it was determined that the phthalocyanine crystal and a compound represented by the formula (1) formed a simple mixture or that a compound represented by the formula (1) was attached to the surface of the phthalocyanine crystal.

On the other hand, when the TG measurement results of the phthalocyanine crystal obtained by adding a compound represented by the formula (1) showed the weight reduction increase at a temperature higher than the completion temperature of the weight reduction for the compound represented by the formula (1) alone in comparison with the TG measurement results of the phthalocyanine crystal prepared without addition of a compound represented by the formula (1), it was determined that a compound represented by the formula (1) was contained in the crystal.

The X-ray diffraction analysis, the NMR measurement, and TG measurement of the phthalocyanine crystal of the present invention were performed under the following conditions.

### [Powder X-Ray Diffraction Analysis]

Measurement instrument: X-ray diffraction analyzer RINT-TTRII made by Rigaku Corporation
   X-ray tube: Cu
   X-ray tube voltage: 50 KV
   X-ray tube current; 300 mA
   Scanning method: 2θ/θ scan
   Scanning rate: 4.0°/min
   Sampling interval: 0.02°
   Starting angle (2θ): 5.0°
   Stopping angle (2θ): 40.0°
   Attachment: Standard sample holder
   Filter: non-use
   Incident monochrome: in-use
   Counter monochrometer: non-use
   Divergence slit: open
   Vertical divergence limiting slit: 10.00 mm
   Scattering slit: open
   Light receiving slit: open
   Flat plate monochrometer: in use
   Counter: scintillation counter

### [NMR Measurement]

Measurement instrument: AVANCE III 500 made by Bruker Solvent: deuterium sulfate (D₂SO₄)

### [TG Measurement]

Measurement instrument: A simultaneous TG/DTA measurement device made by Seiko Instruments Inc. (Trade name: TG/DTA 220U)
Atmosphere: Nitrogen stream (300 ml/min)
Measurement range: 35° C. to 600° C.
Rate of temperature increase: 10° C./min

The phthalocyanine crystal which contains a 4-piperidone compound represented by the formula (1) of the present invention in the crystal has an excellent function as a photoconductive material, and is applicable to a solar cell, a sensor, a switching device and the like, in addition to an electrophotographic photosensitive member.

The use of the phthalocyanine crystal in which a 4-piperidone compound represented by the formula (1) is contained as a charge generating substance of an electrophotographic photosensitive member is described in the following.

A photosensitive layer includes: a single-layer type photosensitive layer having a single layer which contains a charge generating substance and a charge transporting substance; and a laminate type photosensitive layer having a lamination structure of a charge generating layer which contains a charge generating substance and a charge transporting layer which contains a charge transporting substance. The lamination sequence of the charge generating layer and the charge transporting layer may be inverted.

A support having electrical conductivity (conductive support) is suitable. The support may be made of, for example, aluminum, aluminum alloy, copper, zinc, stainless steel, vanadium, molybdenum, chromium, titanium, nickel, indium, gold or platinum. Alternatively, a support may be made of a plastic coated with a vacuum deposited layer of aluminum, aluminum alloy, indium oxide, tin oxide or indium oxide-tin oxide alloy; a plastic or the support coated with conductive particles and a binder resin; a plastic or paper support impregnated with conductive particles; a plastic including a conductive polymer or the like. Examples of the conductive particles include aluminum particles, titanium oxide particles, tin oxide particles, zinc oxide particles, carbon black, and silver particles.

In the present invention, an undercoat layer (also referred to as a barrier layer or an intermediate layer) having a barrier function and an adhesive function may be disposed between the support and the photosensitive layer.

The undercoat layer can be made from a raw material such as polyvinyl alcohol, polyethylene oxide, ethyl cellulose, methyl cellulose, casein, polyamide (e.g. nylon 6, nylon 66, nylon 610, a copolymer nylon, N-alkoxymethylated nylon), polyurethane, glue, aluminum oxide and gelatin. The undercoat layer has a film thickness of 0.1 to 10 μm, preferably 0.5 to 5 μm.

A single-layer type photosensitive layer can be formed by mixing the charge generating substance of phthalocyanine crystal of the present invention and the charge transporting substance in a binder resin solution, applying the mixed liquid to a support, and drying the produced coating film.

The charge generating layer of a laminate type photosensitive layer can be formed by dispersing phthalocyanine crystals of the present invention in a binder resin solution so as to prepare the coating liquid for forming a charge generating layer, applying the coating liquid, and drying the produced coating film.

Alternatively the charge generating layer may be formed by vapor deposition.

The charge transporting layer can be formed by applying a coating liquid for forming a charge transporting layer and drying the produced coating film. The coating liquid for forming a charge transporting layer is obtained by dissolving a charge transporting substance and a binder resin in a solvent.

Examples of the charge transporting substance include a triarylamine-based compound, a hydrazine-based compound, a stilbene-based compound, a pyrazoline-based compound, an oxazole-based compound, a thiazole-based compound and a triallylmethane-based compound.

Examples of the binder resin for use in each layer include polyester, an acrylic resin, polyvinylcarbazole, a phenoxy resin, polycarbonate, polyvinylbutyral, polystyrene, polyvinyl acetate, polysulfone, polyalylate, vinylidene chloride, acrylonitrile copolymer and polyvinyl benzal.

Examples of the application method to form a photosensitive layer include dip coating, spray coating, spinner coating, bead coating, blade coating and beam coating.

A single-layer type photosensitive layer can have a film thickness of 5 to 40 μm, more preferably 10 to 30 μm.

The charge generating layer of a laminate type photosensitive layer can have a film thickness of 0.01 to 10 μm, more preferably 0.1 to 3 μm. The charge transporting layer can have a film thickness of 5 to 40 μm, more preferably 10 to 30 μm.

The content of the charge generating substance of a laminate type photosensitive layer can be 20 to 90% by mass relative to the total mass of the charge generating layer, more preferably 50 to 80% by mass. The content of the charge transporting substance can be 20 to 80% by mass relative to the total mass of the charge transporting layer, more preferably 30 to 70% by mass.

The content of the charge generating substance of a single-layer type photosensitive layer can be 3 to 30% by mass relative to the total mass of the photosensitive layer. The content of the charge transporting substance can be 30 to 70% by mass relative to the total mass of the photosensitive layer.

The phthalocyanine crystal of the present invention may be mixed with another charge generating substance for use as charge generating substance. In that case, the content of the phthalocyanine crystal can be 50% by mass or more relative to the total charge generating substance.

A protective layer may be provided on the photosensitive layer on an as needed basis. The protective layer can be formed by applying a coating liquid for forming a protective layer, which is prepared by dissolving a resin in an organic solvent, on the photosensitive layer, and drying the produced coating film. Examples of the resin for use in the protective layer include polyvinylbutyral, polyester, polycarbonate (e.g., polycarbonate Z and modified polycarbonate), nylon, polyimide, polyallylate, polyurethane, a styrene-butadiene copolymer, a styrene-acrylic acid co-polymer and a styrene-acrylonitrile co-polymer.

The protective layer can have a film thickness of 0.05 to 20 μm.

The protective layer may contain conductive particles or an ultraviolet absorbing agent. Examples of the conductive particles include metal oxide particles such as tin oxide particles.

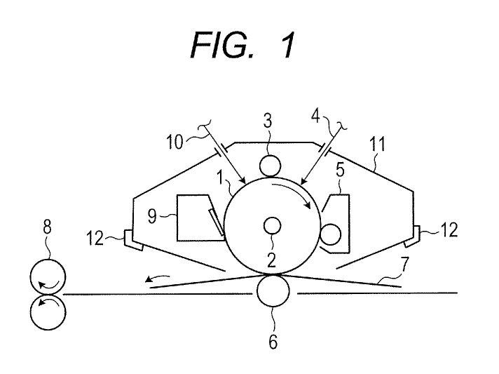

FIG. 1 is a schematic view of an electrophotographic apparatus provided with a process cartridge having an electrophotographic photosensitive member of the present invention.

An electrophotographic photosensitive member 1 having a cylindrical shape (drum shape), is rotation driven around an axis 2 at a predetermined circumferential speed (process speed) in an arrow direction.

The surface of the electrophotographic photosensitive member 1 is electrostatically charged to a positive or negative predetermined potential with a charging device 3 during in a rotation process. Subsequently the charged surface of the electrophotographic photosensitive member 1 is irradiated with image exposing light 4 from an image exposing device (not drawn in figure) so as to form an electrostatic latent image corresponding to objective image information. The image exposing light 4 are intensity-modulated in response to the time-series electric digital image signals of objective image information, outputted from, for example, an image exposing device for slit exposing or exposing with scanning laser beams.

The electrostatic latent image formed on the surface of the electrophotographic photosensitive member 1 is developed (normal development or reversal development) with toner stored in a developing device 5 so as to form a toner image on the surface of the electrophotographic photosensitive member 1. The toner image formed on the surface of the electrophotographic photosensitive member 1 is transferred to a transfer material 7 with a transfer device 6. On this occasion, a bias voltage having a polarity reversal of the charge retained on the toner is applied to the transfer device 6 from a bias power supply (not drawn in figure). A transfer material 7 of paper is taken out from a paper feeding part (not drawn in figure) so as to be fed between the electrophotographic photosensitive member 1 and the transfer device 6 in synchronization with the rotation of the electrophotographic photosensitive member 1.

The transfer material 7 having a toner image transferred from the electrophotographic photosensitive member 1 is separated from the surface of the electrophotographic photosensitive member 1 and transported to an image fixation device 8 for the fixation of the toner image. An image formed object (print or copy) is thus printed out from an electrophotographic apparatus.

After transfer of the toner image to the transfer material 7, the surface of the electrophotographic photosensitive member 1 is cleaned with a cleaning device 9 to remove attached material such as toner (remaining toner after transfer). In a recently developed cleaner-less system, toner may be directly removed after transfer with a development apparatus or the like. Subsequently the surface of the electrophotographic photosensitive member 1 is neutralized with pre-exposing light 10 from a pre-exposing device (not drawn in figure) and then repeatedly used for image formation. The pre-exposing device is not necessarily required for a contact charging device 3 having a charging roller.

In the present invention, a plurality of components selected from the group consisting of the electrophotographic photosensitive member 1, the charging device 3, the developing device 5, and the cleaning device 9 may be contained in a container and integrally supported to form a process cartridge. The process cartridge can be configured to be detachable to an electrophotographic apparatus body. For example, a charging device 3, a developing device 5 and a cleaning device 9 are integrally supported together with the electrophotographic photosensitive member 1 so as to form a cartridge. The cartridge constitutes a process cartridge 11 detachable to an electrophotographic apparatus body with a guiding device 12 such as a rail of the electrophotographic apparatus body.

Image exposing light 4 may be reflected beams from or transmitted beams through a sheet of manuscript for an electrophotographic apparatus such as a copy machine and a printer. Alternatively, image exposing light 4 may be radiated beams produced by scanning of laser beams, driving of an LED array or driving of a liquid crystal shutter array in response to signals from a manuscript reading sensor.

The electrophotographic photosensitive member 1 of the present invention can be widely used in an electrophotography application field such as a laser beam printer, a CRT printer, an LED printer, a FAX, a liquid crystal printer and a laser engraving.

### EXAMPLES

The present invention is described further in detail in reference to specific Examples in the following, although the present invention is not limited thereto. The film thickness of each of the layers of electrophotographic photosensitive members in Examples and Comparative Examples was obtained with an eddy-current film thickness meter (Fischerscope made by Fischer Instruments K.K.), or based on the specific gravity converted from a mass per unit area.

### Example 1-1

As described below, hydroxygallium phthalocyanine was produced by the same as in (synthesis example 1) and (example 1-1) described in Japanese Patent Application Laid-Open No. 2011-94101. Under nitrogen flow atmosphere, 5.46 parts of phthalonitrile and 45 parts of α-chloronaphthalene were fed into a reaction tank, then heated up to a temperature of 30° C., and maintained at the temperature. Subsequently, 3.75 parts of gallium trichloride was fed thereto at the temperature (30° C.). At the feeding time, the mixture liquid had a water content of 150 ppm. The temperature was then increased to 200° C. Under the nitrogen flow atmosphere, a reaction was caused at a temperature of 200° C. for 4.5 hours, which was then cooled to a temperature of 150° C. for filtering a product. The produced residue was dispersed and cleaned with N,N-dimethylformamide at a temperature of 140° C. for 2 hours, and then filtrated. The produced residue was cleaned with methanol and dried to produce 4.65 parts of chlorogallium phthalocyanine pigment (yield: 71%). Subsequently, 4.65 parts of the produced chlorogallium phthalocyanine pigment was dissolved in 139.5 parts of concentrated sulfuric acid at a temperature of 10° C., and instilled into 620 parts of iced water under agitation for reprecipitation. The product was filtrated with a filter press. Subsequently, the produced wet cake (residue) was dispersed and cleaned with 2% ammonia water, and filtrated with a filter press. Subsequently, the produced wet cake (residue) was dispersed and cleaned with ion-exchange water, and then filtration with a filter press was repeated 3 times. Then, hydroxygallium phthalocyanine (hydrous hydroxygallium phthalocyanine) having a solid content of 23% was produced. The produced hydroxygallium phthalocyanine (hydrous hydroxygallium phthalocyanine) in an amount of 6.6 kg was irradiated by microwave with a hyper dryer (trade name: HD-06R, frequency (oscillation frequency): 2,455 MHz±15 MHz, made by Biocon Japan Ltd.) so as to be dried.

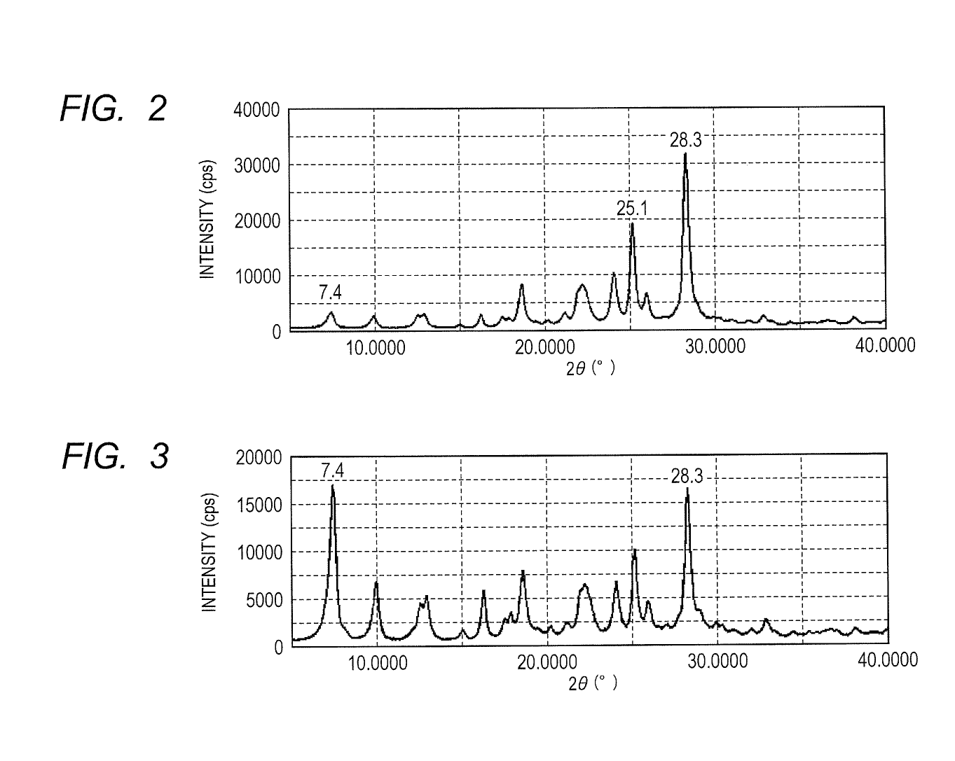

Thus produced 0.5 parts of hydroxygallium phthalocyanine, 0.5 parts of the exemplary compound (1) (product code: M530 made by Tokyo Chemical Industry Co., Ltd.), and 9.5 parts of N,N-dimethylformamide were put in a ball mill with 15 parts of glass beads having a diameter of 0.8 mm so as to be milled at room temperature (23° C.) for 70 hours. A gallium phthalocyanine crystal was produced from the dispersion liquid using N,N-dimethylformamide. In filtration, the strainer was sufficiently cleaned with tetrahydrofuran. The filter residue was vacuum dried so that 0.43 parts of hydroxygallium phthalocyanine crystal was obtained. The powder X-ray diffraction chart of the produced hydroxygallium phthalocyanine crystal is illustrated in FIG. 2.

By NMR measurement, it was confirmed based on the conversion from proton ratio that 0.38% by mass of the exemplary compound (1) and 1.82% by mass of N,N-dimethylformamide were contained in the phthalocyanine crystal. Since the exemplary compound (1) is liquid and compatible with N,N-dimethylformamide, it was found that the exemplary compound (1) was contained in the phthalocyanine crystal.

### Example 1-2

Except that 0.5 parts of the exemplary compound (1) was replaced with 1.0 part of the same and the milling time was changed from 70 hours to 50 hours in Example 1-1, 0.44 parts of hydroxygallium phthalocyanine crystal was obtained by the same treatment as in Example 1-1. The powder X-ray diffraction chart of the produced crystal is illustrated in FIG. 3.

By NMR measurement, it was confirmed that 0.67% by mass of the exemplary compound (1) and 2.14% by mass of N,N-dimethylformamide were contained in the crystal.

### Example 1-3

Except that 9.5 parts of N,N-dimethylformamide was replaced with 9.5 parts of dimethyl sulfoxide and the milling time was changed from 70 hours to 50 hours in Example 1-1, 0.41 parts of hydroxygallium phthalocyanine crystal was obtained by the same treatment as in Example 1-1. The powder X-ray diffraction chart of the produced crystal was the same as in FIG. 3.

By NMR measurement, it was confirmed that 0.79% by mass of the exemplary compound (1) and 2.20% by mass of dimethyl sulfoxide were contained in the crystal. Since the exemplary compound (1) is liquid and compatible with dimethyl sulfoxide, it was found that the exemplary compound (1) was contained in the phthalocyanine crystal.

### Example 1-4

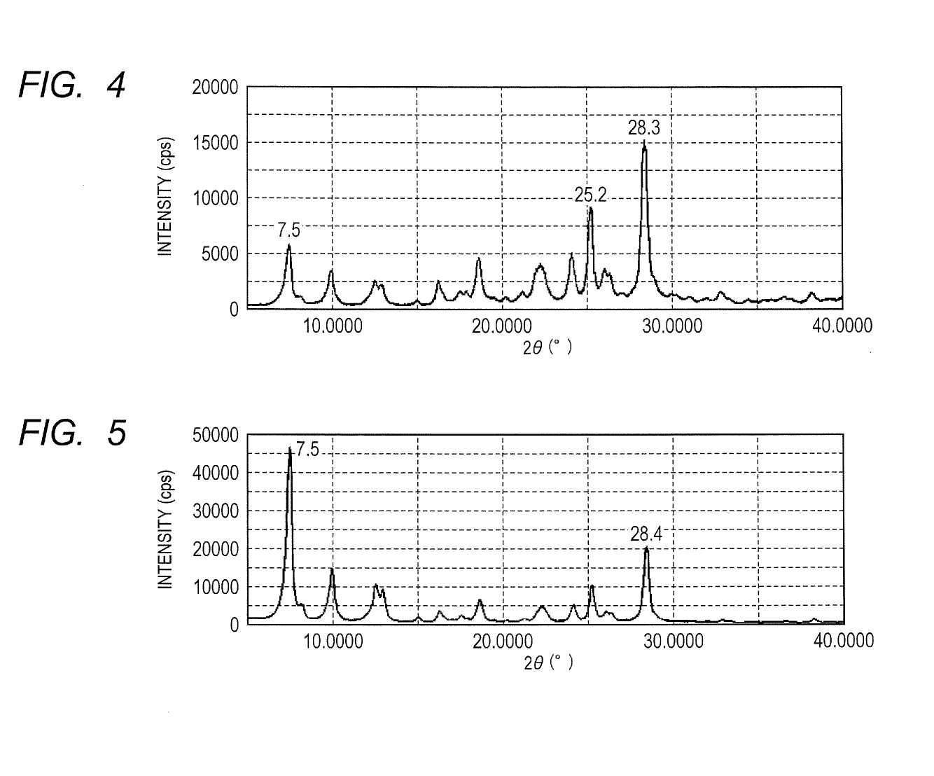

Except that 0.5 parts of the exemplary compound (1) was replaced with 0.5 parts of the exemplary compound (5) (product code: B1027, made by Tokyo Chemical Industry Co., Ltd.) and the milling time was changed from 70 hours to 50 hours in Example 1-1, 0.44 parts of hydroxygallium phthalocyanine crystal was obtained by the same treatment as in Example 1-1. The powder X-ray diffraction chart of the produced crystal is illustrated in FIG. 4.

By NMR measurement, it was confirmed that 0.06% by mass of the exemplary compound (5) and 1.89% by mass of N,N-dimethylformamide were contained in the crystal. Since the exemplary compound (5) is liquid and compatible with N,N-dimethylformamide, it was found that the exemplary compound (5) was contained in the phthalocyanine crystal.

### Example 1-5

Except that 0.5 parts of the exemplary compound (1) was replaced with 0.5 parts of the exemplary compound (9) (product code: 4000343, made by Chembridge Co., Ltd.) and the milling time was changed from 70 hours to 50 hours in Example 1-1, 0.45 parts of hydroxygallium phthalocyanine crystal was obtained by the same treatment as in Example 1-1. The powder X-ray diffraction chart of the produced crystal is illustrated in FIG. 5.

By NMR measurement, it was confirmed that 0.02% by mass of the exemplary compound (9) and 1.97% by mass of N,N-dimethylformamide were contained in the crystal. Since the exemplary compound (9) is a solid soluble in N,N-dimethylformamide, it was found that the exemplary compound (9) was contained in the phthalocyanine crystal.

### Example 1-6

Except that 0.5 parts of the exemplary compound (9) in Example 1-5 was replaced with 1.0 part of the same, 0.45 parts of hydroxygallium phthalocyanine crystal was obtained by the same treatment as in Example 1-5. The powder X-ray diffraction chart of the produced crystal was the same as in FIG. 4.

By NMR measurement, it was confirmed that 0.06% by mass of the exemplary compound (1) and 1.93% by mass of N,N-dimethylformamide were contained in the crystal.

### Example 1-7

Except that 9.5 parts of N,N-dimethylformamide in Example 1-5 was replaced with 9.5 parts of dimethyl sulfoxide, 0.42 parts of hydroxygallium phthalocyanine crystal was obtained by the same treatment as in Example 1-5. The powder X-ray diffraction chart of the produced crystal was the same as in FIG. 3.

By NMR measurement, it was confirmed that 0.06% by mass of the exemplary compound (9) and 2.09% by mass of dimethyl sulfoxide were contained in the crystal. Since the exemplary compound (9) is a solid soluble in dimethyl sulfoxide, it was found that the exemplary compound (9) was contained in the phthalocyanine crystal.

### Example 1-8

Except that 0.5 parts of the exemplary compound (1) was replaced with 9.5 parts of the same without addition of N,N-dimethylformamide and the milling time was changed from 70 hours to 50 hours in Example 1-1, 0.34 parts of hydroxygallium phthalocyanine crystal was obtained by the same treatment as in Example 1-1.

Subsequently, the produced 0.34 parts of hydroxygallium phthalocyanine crystal and 9.5 parts of N,N-dimethylformamide were put in a ball mill with 15 parts of glass beads having a diameter of 0.8 mm so as to be milled at room temperature (23° C.) for 48 hours. A gallium phthalocyanine crystal was produced from the dispersion liquid using N,N-dimethylformamide. In filtration, the strainer was sufficiently cleaned with tetrahydrofuran. The filter residue was vacuum dried so that 0.23 parts of hydroxygallium phthalocyanine crystal was obtained. The powder X-ray diffraction chart of the produced crystal was the same as in FIG. 3.

By NMR measurement, it was confirmed that 0.30% by mass of the exemplary compound (1) and 2.16% by mass of N,N-dimethylformamide were contained in the crystal.

### Example 1-9

Except that 0.5 parts of the exemplary compound (1) was replaced with 9.5 parts of the same without addition of N,N-dimethylformamide and the milling conditions were changed from at room temperature (23° C.) for 48 hours to at 100° C. for 1 hour in Example 1-1, 0.46 parts of hydroxygallium phthalocyanine crystal was obtained by the same treatment as in Example 1-1.

Subsequently, the total amount of produced hydroxygallium phthalocyanine crystal and 9.5 parts of N,N-dimethylformamide were put in a ball mill with 15 parts of glass beads having a diameter of 0.8 mm so as to be milled at room temperature (23° C.) for 48 hours. A gallium phthalocyanine crystal was produced from the dispersion liquid using N,N-dimethylformamide. In filtration, the strainer was sufficiently cleaned with tetrahydrofuran. The filter residue was vacuum dried so that 0.43 parts of hydroxygallium phthalocyanine crystal was obtained. The powder X-ray diffraction chart of the produced crystal was the same as in FIG. 3. By NMR measurement, it was confirmed that 0.88% by mass of the exemplary compound (1) and 0.67% by mass of N,N-dimethylformamide were contained in the crystal.

### Example 1-10

Except that 9.5 parts of the exemplary compound (1) in Example 1-9 was replaced with 9.5 parts of the exemplary compound (5), 0.45 parts of hydroxygallium phthalocyanine crystal was obtained by the same treatment as in Example 1-9. The powder X-ray diffraction chart of the produced crystal was the same as in FIG. 4.

By NMR measurement, it was confirmed that 0.62% by mass of the exemplary compound (5) and 0.85% by mass of N,N-dimethylformamide were contained in the crystal.

### Example 1-11

Except that 9.5 parts of the exemplary compound (1) in Example 1-9 was replaced with 9.5 parts of the exemplary compound (9), 0.40 parts of hydroxygallium phthalocyanine crystal was obtained by the same treatment as in Example 1-9. The powder X-ray diffraction chart of the produced crystal was the same as in FIG. 2.

By NMR measurement, it was confirmed that 2.24% by mass of the exemplary compound (9) and 2.29% by mass of N,N-dimethylformamide were contained in the crystal.

### Example 1-12

Except that 0.5 parts of the exemplary compound (1) was replaced with 0.5 parts of the exemplary compound (21) (product code: B3778, made by Tokyo Chemical Industry Co., Ltd.) and the milling time was changed from 70 hours to 50 hours in Example 1-1, 0.48 parts of hydroxygallium phthalocyanine crystal was obtained by the same treatment as in Example 1-1. The powder X-ray diffraction chart of the produced crystal was the same as in FIG. 4.

By NMR measurement, it was confirmed that 0.25% by mass of the exemplary compound (21) and 2.24% by mass of N,N-dimethylformamide were contained in the crystal. Since the exemplary compound (21) is a solid soluble in N,N-dimethylformamide, it was found that the exemplary compound (21) was contained in the phthalocyanine crystal.

### Example 1-13

Except that 0.5 parts of the exemplary compound (1) was replaced with 0.5 parts of the exemplary compound (17) (product code: AK-17110, made by Ark Pharm, Inc.) and the milling time was changed from 70 hours to 50 hours in Example 1-1, 0.46 parts of hydroxygallium phthalocyanine crystal was obtained by the same treatment as in Example 1-1. The powder X-ray diffraction chart of the produced crystal was the same as in FIG. 4.

By NMR measurement, it was confirmed that 0.53% by mass of the exemplary compound (17) and 1.90% by mass of N,N-dimethylformamide were contained in the crystal. Since the exemplary compound (17) is a solid soluble in N,N-dimethylformamide, it was found that the exemplary compound (17) was contained in the phthalocyanine crystal.

### Comparative Example 1-1

Except that the exemplary compound (1) in Example 1-2 was not added, 0.44 parts of hydroxygallium phthalocyanine crystal was obtained by the same treatment as in Example 1-2. The powder X-ray diffraction of the produced hydroxygallium phthalocyanine crystal was the same as in FIG. 5.

### Comparative Example 1-2

Except that 1.0 parts of the exemplary compound (1) in Example 1-2 was replaced with 1.0 part of 2,2,6,6-tetramethylpiperidine, 0.45 parts of hydroxygallium phthalocyanine crystal was obtained by the same treatment as in Example 1-2.

### Comparative Example 1-3

Except that 1.0 parts of the exemplary compound (1) in Example 1-2 was replaced with 1.0 part of N-ethylpyrrolidine, 0.45 parts of hydroxygallium phthalocyanine crystal was obtained by the same treatment as in Example 1-2.

### Comparative Example 1-4

Except that 1.0 parts of the exemplary compound (1) in Example 1-2 was replaced with 1.0 parts of N-methyl-2-pyrrolidone, 0.42 parts of hydroxygallium phthalocyanine crystal was obtained by the same treatment as in Example 1-2.

### Comparative Example 1-5

Except that 9.5 parts of N,N-dimethylformamide in Comparative Example 1-1 was replaced with 9.5 parts of N-methyl-2-pyrrolidone, 0.39 parts of hydroxygallium phthalocyanine crystal was obtained by the same treatment as in Comparative Example 1-1.

### Example 2-1

Firstly, a solution including 60 parts of barium sulfate particles coated with tin oxide (trade name: Passtran PC1, made by Mitsui Mining & Smelting Co., Ltd.), 15 parts of titanium oxide particles (trade name: TITANIX JR, made by Tayca Corporation), 43 parts of a resol-type phenol resin (trade name: Phenolite J-325 made by DIC Corporation, solid content: 70% by mass), 0.015 parts of silicone oil (trade name: SH28PA, made by Dow Corning Toray Co., Ltd.), 3.6 parts of silicone resin (trade name: Tospearl 120, made by Momentive Performance Materials Inc.), 50 parts of 2-methoxy-1-propanol, and 50 parts of methanol was put in a ball mill, and dispersed for 20 hours so as to prepare a coating liquid for forming a conductive layer.

The coating liquid for forming a conductive layer was applied on aluminum cylinder (diameter: 24 mm) as a support with immersion coating, and the produced coating film was dried at 140° C. for 30 minutes so that a conductive layer having a film thickness of 15 μm was formed.

Subsequently 10 parts of copolymer nylon resin (trade name: Amilan CM8000, made by Toray Industries, Inc.) and 30 parts of methoxymethylated 6-nylon resin (trade name: Tresin EF-30T, made by Nagase Chemtex Corporation) were dissolved in a mixed solvent of 400 parts of methanol and 200 parts of n-butanol so as to prepare a coating liquid for forming an undercoat layer.

The coating liquid for forming an undercoat layer was applied to the conductive layer with immersion coating, and the produced coating film was dried so that an undercoat layer having a film thickness of 0.5 μm was formed.

Subsequently, 10 parts of the hydroxygallium phthalocyanine crystal (charge generating substance) produced in Example 1-1, 5 parts of polyvinylbutyral (trade name: S-LEC BX-1, made by Sekisui Chemical Co., Ltd.), and 250 parts of cyclohexanone were put in a sand mill with glass beads having a diameter of 1 mm for dispersion treatment for 4 hours. To the dispersion liquid, 250 parts of ethyl acetate was added to dilute it, thereby preparing a for forming a charge generating layer.

The coating liquid for forming a charge generating layer was applied to the undercoat layer with immersion coating. The produced coating film was dried at 100° C. for 10 minutes to form the charge generating layer having a film thickness of 0.16 μm.

Subsequently, 8 parts of a compound (charge transporting substance) represented by the following formula (3) and 10 parts of polycarbonate (trade name: Iupilon Z-200, made by Mitsubishi Engineering-Plastics Corporation) were dissolved in 70 parts of monochlorobenzene so as to prepare a coating liquid for forming a charge transporting layer.

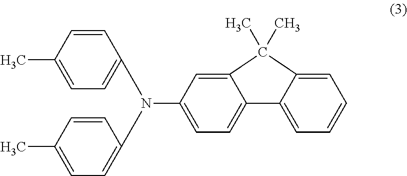 [SMILES: Cc1ccc(N(c2ccc(C)cc2)c2ccc3c(c2)C(C)(C)c2ccccc2-3)cc1]

The coating liquid for forming a charge transporting layer was applied to the charge generating layer by immersion coating. The produced coating film was dried at 110° C. for 1 hour to form a charge transporting layer having a film thickness of 23 μm.

The electrophotographic photosensitive member of Example 2-1 in a cylindrical shape (drum shape) was thus manufactured.

### Examples 2-2 to 2-13

Except that the hydroxygallium phthalocyanine crystal in preparing the coating liquid for forming a charge generating layer in Example 2-1 was replaced with the hydroxygallium phthalocyanine crystals produced in Examples 1-2 to 1-13, the electrophotographic photosensitive members in Examples 2-2 to 2-13 were made in the same way as in Example 2-1.

### Comparative Examples 2-1 to 2-5

Except that the hydroxygallium phthalocyanine crystal in preparing the coating liquid for forming a charge generating layer in Example 2-1 was replaced with the hydroxygallium phthalocyanine crystals produced in Comparative Examples 1-1 to 1-5, the electrophotographic photosensitive members in Comparative Examples 2-1 to 2-5 were made in the same way as in Example 2-1.

### Comparative Example 2-6

Except that 10 parts of hydroxygallium phthalocyanine crystal in preparing a coating liquid for forming a charge generating layer in Example 2-1 was replaced with 10 parts of the hydroxygallium phthalocyanine crystal produced in Comparative Example 1-1 and 0.2 parts of the exemplary compound (1) (product code: M530, made by Tokyo Chemical Industry Co., Ltd), the electrophotographic photosensitive member in Comparative Example 2-6 was made in the same way as in Example 2-1.

### Evaluation of Examples 2-1 to 2-13 and Comparative Examples 2-1 to 2-6

The electrophotographic photosensitive members of Examples 2-1 to 2-13 and Comparative Examples 2-1 to 2-6 were evaluated for ghost images.

A laser beam printer made by Hewlett Packard Japan, Ltd (trade name: Color Laser Jet CP3525dn) was modified to use as an electrophotographic apparatus for evaluation. As a result of modification, a pre-exposing light was unlit and charging conditions and the amount of image exposure were variably controlled. In addition, a manufactured electrophotographic photosensitive member was mounted in a process cartridge for cyan color and attached to the station of the process cartridge for cyan, allowing for operation without mounting of process cartridges for other colors to the laser beam printer main body.

In outputting an image, the process cartridge for cyan color alone was attached to the main body so that a single color image was outputted using cyan toner alone.

The charging conditions and the amount of image exposure were adjusted such that the initial potential was set at −500V for a dark part and −100V for a bright part under a normal temperature and normal humidity environment of 23° C./55% RH. In the measurement of the surface potential of a drum-shaped electrophotographic photosensitive member for potential setting, the cartridge was firstly modified and a potential probe (trade name: model 6000B-8, made by Trek Japan Co., Ltd.) was mounted at the development position. The potential at the center of an electrophotographic photosensitive member in a cylindrical shape was measured with a surface potential meter (trade name: model 344, made by Trek Japan Co., Ltd).

Ghost images were then evaluated under the same conditions. Subsequently, a repeated paper feed test was performed with 1,000 sheets of paper fed through, and ghost images were evaluated immediately after and 15 hours after the repeated paper feed test. Evaluation results under a normal temperature and normal humidity environment are described in Table 1.

Subsequently, the electrophotographic photosensitive member was left to stand under a low temperature and low humidity environment of 15° C./10% RH together with the electrophotographic apparatus for evaluation for 3 days so as to evaluate ghost images. A repeated paper feed test was performed with 1,000 sheets of paper fed through under the same conditions, and ghost images were evaluated immediately after and 15 hours after the repeated paper feed test. Evaluation results under the low temperature and low humidity environment are also described in Table 1.

In the repeated paper feed test with paper fed through, an image of character E with a coverage rate of 1% was formed on a plain paper of A4 size with cyan single color.

Ghost images were evaluated as follows.

The evaluation was performed based on the ghost images on 8 sheets in total outputted in succession in the following order: outputting a solid white image on a first sheet, outputting 4 types of ghost charts on respective 4 sheets in total, outputting a solid black image on a sheet, and outputting the 4 types of ghost charts on respective 4 sheets in total once again. The ghost chart includes 4 solid black square images of 25 mm side arranged in parallel at equal intervals in the 30 mm-width region from the starting position of output images (10 mm from the top edge of paper) as a solid white background. In the region below the 30 mm-width region from the starting position of output images, 4 types of halftone printing patterns were printed. Ranks were classified based on 4 types of ghost charts.

The 4 types of ghost charts are charts arranged in the region below the 30-mm width region from the starting position of output images, with only difference in halftone pattern. The halftone patterns include the following 4 types:
(1) a printing pattern (laser exposing) with 1 dot and 1 space in lateral* direction;
(2) a printing pattern (laser exposing) with 2 dots and 2 spaces in lateral* direction;
(3) a printing pattern (laser exposing) with 2 dots and 3 spaces in lateral* direction; and
(4) a knight jump printing pattern (laser exposing) (a pattern with 2 dots printed in 6 squares in the knight jump direction).
*: The lateral direction means the scanning direction of a laser scanner (the horizontal direction of an outputted sheet).

The ghost images were classified into ranks as follows. It was determined that the effect of the present invention was insufficient in the ranks 4, 5 and 6.

Rank 1: No ghosting was visible in any of the ghost charts.
Rank 2: Ghosting was vaguely visible in a specific ghost chart.
Rank 3: Ghosting was vaguely visible in any of the ghost charts.
Rank 4: Ghosting was visible in a specific ghost chart.
Rank 5: Ghosting was visible in any of the ghost charts.
Rank 6: Ghosting was sharply visible in a specific ghost chart.

TABLE 1

| | Under normal temperature and | | | Under low temperature and low | | |
|---|---|---|---|---|---|---|
| | normal humidity environment | | | humidity environment | | |
| | | Immediately | 15 hours | | Immediately | 15 hours |
| | | after | after | | after | after |
| | Initial | durability | durability | Initial | durability | durability |
| | stage | test | test | stage | test | test |
| | Ghosting | Ghosting | Ghosting | Ghosting | Ghosting | Ghosting |
| | rank | rank | rank | rank | rank | rank |
| Example 2-1 | 1 | 2 | 2 | 2 | 3 | 2 |
| Example 2-2 | 1 | 2 | 2 | 2 | 3 | 2 |
| Example 2-3 | 1 | 2 | 2 | 2 | 3 | 3 |
| Example 2-4 | 1 | 2 | 2 | 2 | 3 | 2 |
| Example 2-5 | 1 | 1 | 1 | 1 | 2 | 1 |
| Example 2-6 | 1 | 2 | 1 | 1 | 2 | 1 |
| Example 2-7 | 1 | 2 | 1 | 1 | 2 | 2 |
| Example 2-8 | 2 | 2 | 2 | 2 | 3 | 2 |
| Example 2-9 | 1 | 2 | 2 | 2 | 3 | 2 |
| Example 2- | 1 | 2 | 2 | 2 | 3 | 3 |
| 10 | | | | | | |
| Example 2- | 1 | 1 | 1 | 1 | 2 | 1 |
| 11 | | | | | | |
| Example 2- | 2 | 3 | 2 | 2 | 3 | 3 |
| 12 | | | | | | |
| Example 2- | 1 | 2 | 2 | 1 | 2 | 2 |
| 13 | | | | | | |
| Comparative | 4 | 5 | 4 | 5 | 6 | 5 |
| Example 2-1 | | | | | | |
| Comparative | 4 | 5 | 5 | 5 | 6 | 6 |
| Example 2-2 | | | | | | |
| Comparative | 4 | 4 | 4 | 4 | 5 | 5 |
| Example 2-3 | | | | | | |
| Comparative | 5 | 6 | 6 | 6 | 6 | 6 |
| Example 2-4 | | | | | | |
| Comparative | 3 | 5 | 4 | 5 | 6 | 5 |
| Example 2-5 | | | | | | |
| Comparative | 4 | 5 | 4 | 5 | 6 | 5 |
| Example 2-6 | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-111651, filed May 28, 2013, which is hereby incorporated by reference herein in its entirety.

1. An electrophotographic photosensitive member comprising:
a support; and
a photosensitive layer formed on the support;
wherein the photosensitive layer comprises:
a phthalocyanine crystal in which a compound represented by the following formula (1) is contained; 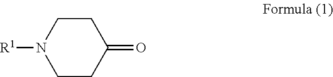
wherein,
R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted hetero ring group, with the proviso that, as a substituent of the substituted aryl group, an acetyl group and a benzoyl group are excluded.

2. The electrophotographic photosensitive member according to claim 1, wherein
the R¹ in the formula (1) is a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted heterocyclic group;
the substituent of the substituted alkyl group is an alkoxy group, a morpholinoalkoxy group, a dialkylamino group, an alkoxycarbonyl group, an aryl group, an aryloxy group, a halogen atom, a cyano group or a morpholino group;
the substituent of the substituted aryl group is an alkyl group, an alkoxy group, a dialkylamino group, an alkoxycarbonyl group, a halogen atom, a nitro group, a cyano group, a formyl group or a morpholino group; and
the substituent of the substituted heterocyclic group is an alkyl group, an alkoxy group, a dialkylamino group, an alkoxycarbonyl group, a halogen atom, a nitro group, a cyano group, a formyl group or a morpholino group.

3. The electrophotographic photosensitive member according to claim 2, wherein
the R¹ in the formula (1) is a substituted or unsubstituted alkyl group, and
the substituent of the substituted alkyl group is an alkoxy group, a morpholinoalkoxy group, a dialkylamino group, an alkoxycarbonyl group, an aryl group, a halogen atom, a cyano group, or a morpholino group.

4. The electrophotographic photosensitive member according to claim 3, wherein the R¹ in the formula (1) is a methyl group, an ethyl group, or a benzyl group.

5. The electrophotographic photosensitive member according to claim 2, wherein
the R¹ in the formula (1) is a substituted or unsubstituted phenyl group, and
the substituent of the substituted phenyl group is an alkyl group, an alkoxy group, a halogen atom, a formyl group, a cyano group, or a nitro group.

6. The electrophotographic photosensitive member according to claim 5, wherein the R¹ in the formula (1) is an unsubstituted phenyl group.

7. The electrophotographic photosensitive member according to claim 1, wherein the phthalocyanine crystal is a gallium phthalocyanine crystal.

8. The electrophotographic photosensitive member according to claim 7, wherein the gallium phthalocyanine crystal is a gallium phthalocyanine crystal in which N,N-dimethylformamide is contained.

9. The electrophotographic photosensitive member according to claim 7, wherein the gallium phthalocyanine crystal is a hydroxygallium phthalocyanine crystal.

10. The electrophotographic photosensitive member according to claim 9, wherein the hydroxygallium phthalocyanine crystal is a hydroxygallium phthalocyanine crystal having peaks at Bragg angles 2θ of 7.4°±0.3° and 28.3°±0.3° in X-ray diffraction with CuKα radiation.

11. The electrophotographic photosensitive member according to claim 1, wherein the content of the compound represented by the formula (1) in the phthalocyanine crystal is 0.01% by mass or more and 3% by mass or less.

12. A process cartridge which integrally supports: an electrophotographic photosensitive member; and at least one device selected from the group consisting of a charging device, a developing device, a transfer device and a cleaning device, the cartridge being detachably mountable to a main body of an electrophotographic apparatus,
wherein the electrophotographic photosensitive member comprises:
a support; and
a photosensitive layer formed on the support,
wherein the photosensitive layer comprises:
a phthalocyanine crystal in which a compound represented by the following formula (1) is contained; 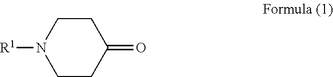
wherein
R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted hetero ring group, with the proviso that, as a substituent of the substituted aryl group, an acetyl group and a benzoyl group are excluded.

13. An electrophotographic apparatus comprising:
an electrophotographic photosensitive member; with
a charging device, an exposing device, a developing device and a transfer device,
wherein the electrophotographic photosensitive member comprises:
a support; and
a photosensitive layer formed on the support,
wherein the photosensitive layer comprises:
a phthalocyanine crystal in which a compound represented by the following formula (1) is contained; 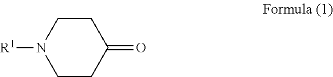
wherein,
R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted hetero ring group, with the proviso that, as a substituent of the substituted aryl group, an acetyl group and a benzoyl group are excluded.

14. A phthalocyanine crystal in which a compound represented by the following formula (1) is contained: 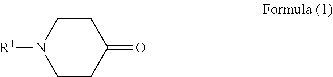
wherein R¹ represents a formyl group, an acetyl group, a benzoyl group, an alkyloxycarbonyl group, a benzyloxycarbonyl group, an alkenyl group, a substituted or unsubstituted alkyl group, a substituted or unsubstituted aryl group, or a substituted or unsubstituted heterocyclic group, with the proviso that the substituent of the aryl group is not an acetyl group or a benzoyl group.
